(19) United States
(12) Patent Application Publication
(10) Pub. No.: US 2016/0146147 A1
(43) Pub. Date: May 26, 2016

(54) MODULE FOR CONTROLLING FUEL PRESSURE IN AN INTERNAL COMBUSTION ENGINE

(71) Applicant: WESTPORT POWER INC., Vancouver, British Columbia (CA)

(72) Inventors: Randall T. MARK, Nanoose Bay (CA); James D. WALKER, Malvern (GB)

(21) Appl. No.: 14/900,978

(22) PCT Filed: Jun. 20, 2014
(86) PCT No.: PCT/CA2014/050583

§ 371 Date: Dec. 22, 2015

(30) Foreign Application Priority Data
Jun. 28, 2013 (CA) 2,820,013

(51) Int. Cl. F02D 41/38; F02D 41/00; F02M 21/02; F02M 55/02

(52) U.S. Cl. CPC F02D 41/3863; F02M 55/025; F02D 41/0027; F02M 21/023; F02M 21/0245; F02D 2041/3881

(57) ABSTRACT

A module for controlling a first fuel rail pressure in an internal combustion engine and maintaining a predetermined pressure bias with a second fuel rail pressure comprises a manifold body and several components that are mounted on the manifold body to form an unitary and independent structure that is fluidly connected to a first fuel supply and to a first fuel rail. The components that are mounted on the manifold body are a pressure regulator, a shut-off valve and a check valve and can further comprise, for example, a service valve for venting the fuel from the module and/or a sensor for measuring the pressure in the first fuel rail.

### TECHNICAL FIELD

The present invention relates to a module for controlling fuel pressure in an internal combustion engine, more specifically to a module for controlling the pressure of one fuel with a pressure bias relative to the pressure of a second fuel.

### BACKGROUND OF THE INVENTION

Presently, most over-the-road heavy vehicles are fuelled by gasoline or diesel fuel. There are certain shortcomings to using such fuels. They are in limited supply, and most importantly, they have an adverse impact on the environment due to the amount of pollutant gases released into the atmosphere when such fuels are combusted.

More recently, internal combustion engines are being developed that can operate efficiently with reduced levels of pollutants in the engine exhaust if fuelled with cleaner burning fuels such as natural gas, or other combustible gaseous fuels, such as, by way of example, methane, propane, butane, hydrogen, and blends of such fuels. In a preferred method, it is possible to substantially match the performance and efficiency of diesel or gasoline engines by delivering high-pressure gaseous fuel to an engine for injection directly into the combustion chamber.

A challenge with substituting gaseous fuels such as natural gas for liquid fuel in an engine designed to be fuelled with liquid fuels is that without some form of ignition assist, much higher temperatures and pressures are normally needed to auto-ignite gaseous fuels. Therefore, in order to burn a gaseous fuel in a conventional engine with the same compression ratio without having to completely redesign the engine, some mechanism is required to assist with ignition of the gaseous fuel, such as a hot surface provided by a glow plug, or a fuel injection valve for introducing a pilot fuel, such as diesel fuel. If the amount of pilot fuel is small, the amount of pollutants that the engine produces can be significantly reduced.

A problem with delivering two different fuels for injection into the combustion chambers of an internal combustion engine is that it can be difficult to find the physical space for all the components of the system, more specifically for the two fuel injection valves for each cylinder, for the two high pressure fuel rails, and the drain rails for taking away fuel that is drained from the control chambers of hydraulically actuated fuel injection valves and for all the other components involved in controlling the injection of the two fuels.

A solution to the problem of requiring two fuel injection valves is to combine the gaseous fuel injection valve and the pilot fuel injection valve in a single body, for example, as described in the applicant's disclosure in U.S. Pat. No. 6,073,862. A challenge with this approach is keeping the gaseous fuel from leaking into the pilot fuel. Such leakage can be prevented by controlling gaseous fuel pressure to maintain a predetermined pressure bias with the pilot fuel pressure by using a pressure regulator which uses the pilot fuel pressure as a reference pressure. Alternatively, the engine can be calibrated based on the required gaseous fuel pressure and the pilot fuel pressure is then controlled to be higher than the gaseous fuel pressure. In both alternatives, the pressure regulator is designed to maintain a pressure bias between the two fuels to prevent leakage of a first fuel into the second fuel. The gaseous fuel supply system also comprises other components, for example, valves for preventing the backflow of fuel to the tank, for venting the pressure in the fuel supply line and for shutting down the fuel supply when needed.

Mounting such additional controls on the engine represents a challenge when a conventional gasoline or diesel engine system is redesigned to operate with two fuels because of the limited free space available on the engine block or on the cylinder head.

In the past, this problem has been addressed by installing the additional components required for operating the engine with two fuels, in the space available, separate from each and fluidly connecting these components through piping. While this solution meets the functional requirements for operating the engine, such mounting can become complex in some engine systems. In addition, such piping adds to the total volume of the high pressure fuel supply system and a system with a lower overall volume can be operated more efficiently, and results in less high pressure gaseous that needs to be relieved when the system is shut down. Yet another disadvantage associated with extra piping is that each pipe connection introduces more potential leak points.

While the solutions from the prior art as described above solve the problem of adapting a conventional diesel or gasoline engine to be fueled with a pilot ignited gaseous fuel, there is still a need for a simpler and compact solution for installing additional components needed to control the pressure of a first fuel relative to a second fuel.

### SUMMARY

A module is disclosed for controlling a first fuel rail pressure in an internal combustion engine and maintaining a predetermined pressure bias with a second rail fuel pressure, both fuels being directly injected into the engine combustion chamber. The module comprises a manifold body having an inlet into the manifold body for receiving the first fuel into internal fuel passages defined by the manifold body, and an outlet from the manifold body for delivering the first fuel to a first fuel rail. The module comprises a pressure regulator for controlling the rail pressure of the first fuel as a function of said second fuel rail pressure which is used as a reference pressure for maintaining said pressure bias. The pressure regulator comprises a first inlet for receiving the first fuel which is fluidly connected through a first passage provided in the manifold body to the inlet of the manifold body, a second inlet for receiving the second fuel and an outlet for delivering the first fuel with a predetermined pressure bias, wherein the outlet of the pressure regulator is fluidly connected to the outlet of said manifold body through a second passage provided in the manifold body. The module further comprises a check valve having an inlet fluidly connected through the first passage in the manifold body to the inlet of said manifold body and to the pressure regulator and a shut-off valve for shutting down fluid flow to the first fuel rail. The shut-off valve has an inlet fluidly connected through the first passage in the manifold body to the inlet of said manifold body.

The pressure regulator, the check valve and the shut-off valve are installed on the manifold body to form a unitary and independent structure. This means that these components are installed to form a compact assembly which allows the fluid communication between the components through the internal passages in the manifold body of the module while allowing the flexibility of moving these components together as one structural unit which can be mounted at different locations on the engine.

The module for controlling first fuel rail pressure further comprises a vent outlet for venting first fuel from the module, the vent outlet being fluidly connected to the pressure regulator through a third passage provided in the manifold body.

The module can further comprise a service valve for venting fuel from the module during engine servicing which is installed on the manifold body and is fluidly connected through the third passage in the manifold body to the vent outlet.

In preferred embodiments, the manifold body of the module for controlling first fuel rail pressure is installed on a manifold body of a second fuel control module for controlling the second fuel rail pressure. The manifold body of the second fuel control module comprises a second fuel drain inlet, a second fuel drain outlet, a port for fluidly connecting second fuel control module to the module for controlling first fuel rail pressure and a port for fluidly connecting the manifold body of the second fuel control module to the first fuel rail.

The second fuel control module can comprise a second fuel pressure relief valve which is mounted on the manifold body of the second fuel control module. The second fuel pressure relief valve is connected through passages in the manifold body of the second fuel control module to the second fuel drain inlet and to the second fuel drain outlet.

The second fuel control module can further comprise at least one of a second fuel return valve, a second fuel return pressure sensor, a second fuel rail pressure sensor and a second fuel drain check valve which can be mounted on the manifold body of the second fuel control module and are connected through passages in the manifold body of the second fuel control module to the second fuel drain inlet and to second fuel drain outlet.

The manifold body of the second fuel control module can have at least one prolonged end which is shaped to accommodate the mounting of a system component, for example a filter for the second fuel.

The assembly formed by the module for controlling the first fuel rail pressure and the second fuel control module can be mounted on the engine block, on the cylinder head of the engine or on the frame of a vehicle powered by the engine.

In some embodiments, the manifold body of the module for controlling the first fuel rail pressure is mounted on a cylinder head of the engine, on the engine block or on the frame of the vehicle powered by the engine and is fluidly connected through piping to the second fuel control module that is mounted on the cylinder head, on the engine block or on the vehicle frame at a separate location from the location of the module for controlling the first fuel rail pressure.

A method is disclosed for installing a module for controlling a first fuel rail pressure on board of an internal combustion engine fuelled with a first fuel and a second fuel which are directly injected into a combustion chamber of the engine. The module being installed comprises a manifold body, a regulator for controlling the rail pressure of the first fuel to maintain a predetermined pressure bias with a second fuel rail pressure, a shut-off valve and check valve. The method comprises placing the manifold body of the module for controlling the first fuel rail pressure on the manifold body of a second fuel control module and mounting it thereto, and fluidly connecting the manifold body of the module for controlling the first fuel rail pressure to a first fuel supply and a first fuel rail. The second fuel control module can be mounted for example on the engine block, on the cylinder head of the engine or on the frame of a vehicle powered by the engine.

In another embodiment of the present method of installing a module for controlling a first fuel rail pressure on board of an internal combustion engine fuelled with a first fuel and a second fuel which are both directly injected into a combustion chamber of the engine, comprises placing the manifold body of the module for controlling the first fuel rail pressure on the engine block, on the cylinder head of the engine or on the frame of the vehicle powered by the engine, mounting it thereto and fluidly connecting the manifold body of this module to a first fuel supply, to a first fuel rail and to the components of a second fuel control module which is mounted on the engine block, on the cylinder head of the engine or on the vehicle frame at a different location from the location of the module for controlling the first fuel rail pressure.

### BRIEF DESCRIPTION OF THE DRAWINGS

The drawings illustrate specific preferred embodiments of the invention, but should not be considered as restricting the spirit or scope of the invention in any way.

FIG. 1 is a schematic hydraulic diagram of a fuel supply system for a six cylinder engine fuelled with two different fuels and employing a module for controlling the pressure of a first fuel rail pressure and a second fuel control module;

FIG. 2A illustrates a schematic hydraulic diagram of the module which controls the pressure of the first fuel;

FIG. 3 illustrates a perspective semi-exploded view of the assembly comprising the module for controlling the pressure of the first fuel and the second fuel control module;

FIG. 4 is a perspective view of the module for controlling the first fuel rail pressure assembled together with the second fuel control module;

FIG. 5 illustrates the front view of the module for controlling the first fuel rail pressure showing the internal passages in its manifold body that allow the fluid connection between the different module components;

FIG. 6 illustrates the front view, the left and right side views and the top view of the second fuel control module showing the internal passages in the manifold body that allow the fluid connection between the different module components; and

FIGS. 7A and 7B illustrate two variants for placing the module for controlling the first fuel rail pressure and the second fuel module on the engine block and, respectively, on the cylinder head of an internal combustion engine.

### DETAILED DESCRIPTION OF THE PREFERRED EMBODIMENTS

The module for controlling a first fuel rail pressure illustrated in the preferred embodiments can be used in any internal combustion engine fuelled with two fuels, where both fuels are injected directly into the combustion chamber of the engine and where the pressure of the first fuel is controlled as a function of the pressure of the second fuel which is used as a reference for maintaining a bias between the pressures of the two fuels.

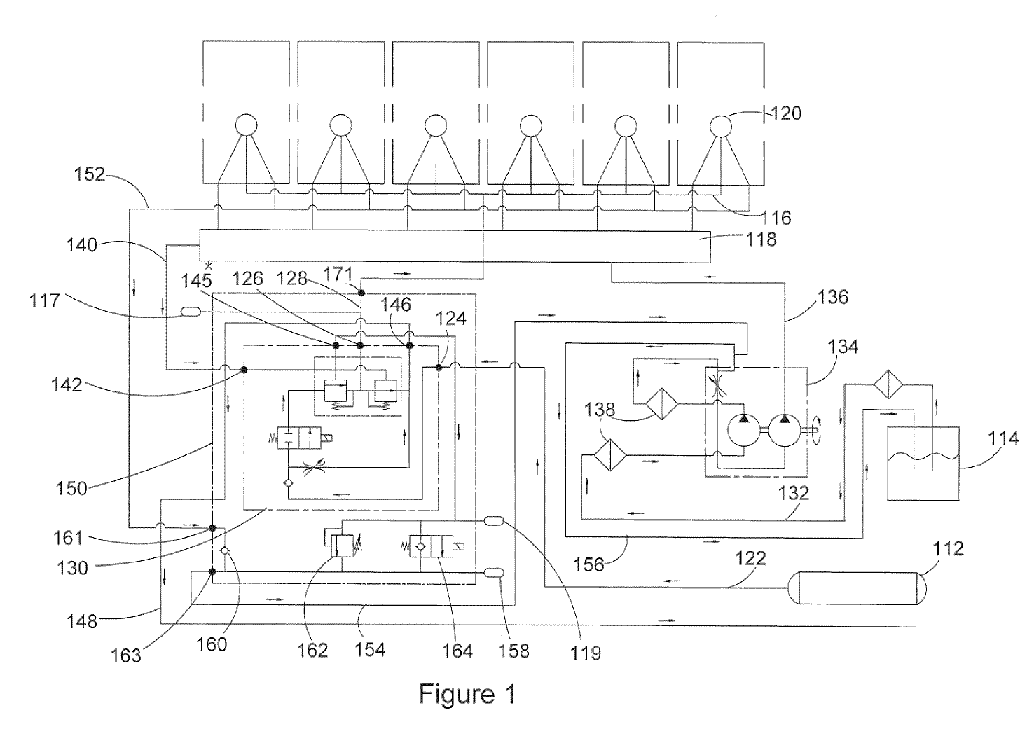

The embodiments disclosed herein are described, by way of example, in relation to a gaseous fuelled internal combustion engine illustrated in FIG. 1 which is fueled with a gaseous fuel (first fuel) as the main fuel and a liquid fuel (second fuel) as a pilot fuel, but the present disclosure will be understood to apply more generally, to other engines fueled with two fuels when it is important to maintain a pressure bias to prevent one fuel from leaking into another fuel.

The engine shown in FIG. 1 is a six cylinder engine but the disclosed modules can be employed with engines with any number of cylinders. FIG. 1 is a schematic diagram that shows how the two fuels are directed from the respective fuel supplies, through the pressure control modules and to fuel injectors 120 for injection into the respective combustion chambers.

The first fuel is supplied from first fuel supply 112 through supply line 122 to inlet 124 of module 130 for controlling the first fuel rail pressure, and from the outlet 126 of module 130 first fuel flows through supply line 128 to first fuel rail 116. Second fuel is supplied from second fuel supply 114 through supply line 132 to pump assembly 134 and from pump assembly 134 second fuel flows through supply line 136 to second fuel rail 118. Second fuel is filtered through filters 138 which are fluidly connected to supply line 132.

Second fuel rail 118 is fluidly connected to module 130 through line 140 which connects to reference fuel inlet 142 of module 130. Through this fluid connection the second fuel can flow into module 130 to provide the reference pressure for controlling the pressure of the first fuel such that a pressure bias is maintained between the two fuel pressures. Module 130 also has a vent outlet 146 fluidly connected to vent line 148 which can be connected to the atmosphere as illustrated in FIG. 1 or it can be connected to a system for capturing the vent gases. The second fuel flows out of module 130 through outlet 145.

As illustrated in FIG. 1 second fuel control module 150 comprises a second fuel drain check valve 160 which is fluidly connected to line 152 which collects the second fuel drained from injectors 120 and a pressure relief valve 162 which is fluidly connected through the fluid passages in module 130 and through line 140 to second fuel rail 118. Pressure relief valve 162 opens if the pressure in second fuel rail 118 increases over a predetermined threshold. Second fuel control module 150 can also comprise a second fuel return valve 164 which is connected in parallel to pressure relief valve 162 and which can be commanded to allow the gradual release of fuel from second fuel rail 118 and line 140 at shut-down. Second fuel control module 150 generally also comprises second fuel rail pressure sensor 119 which measures the pressure in second fuel rail 118 and second fuel return pressure sensor 158 which measures the pressure in drain line 154.

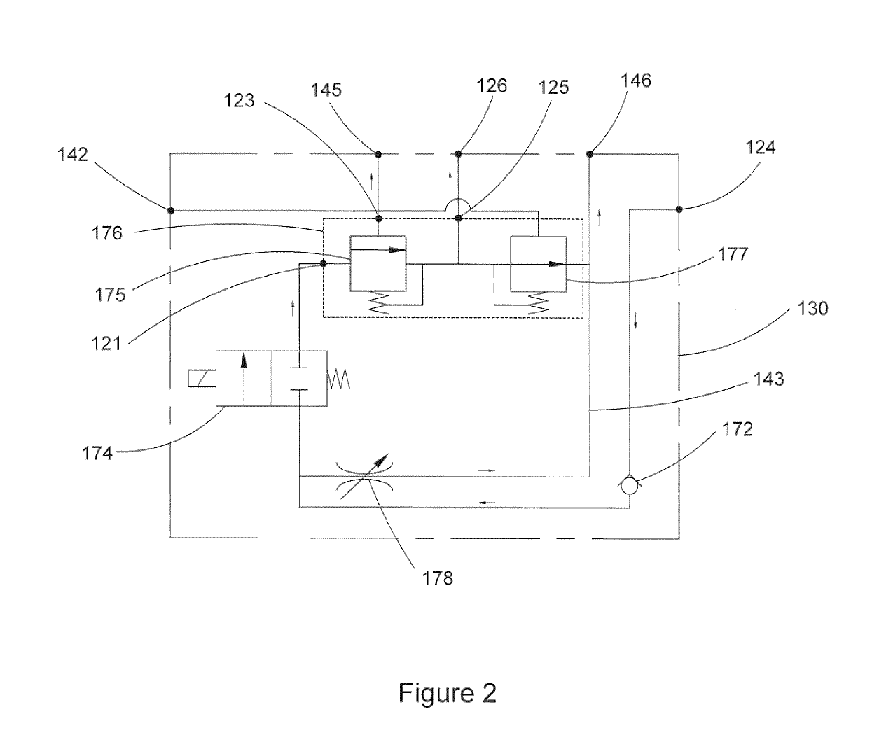

The components of module 130 for controlling the first fuel rail pressure are better illustrated in FIG. 2. The first fuel is supplied to module 130 through inlet 124 and is directed through check valve 172 and shut-off valve 174 to pressure regulator 176. Pressure regulator 176 receives the first fuel through a first inlet 121 and the second fuel through a second inlet 123 and delivers the first fuel at a predetermined pressure bias compared to a second fuel rail pressure through outlet 125. Pressure regulator 176 comprises a pressure regulator valve 175 and a vent valve 177. Pressure regulator 176 regulates the pressure of first fuel to a predetermined value to maintain a predetermined pressure bias with the second fuel rail pressure. The construction and the operation of such a pressure regulator are known to a person skilled in the art and are therefore not described here. Module 130 further comprises a service valve 178 for venting fuel from the module and from the first fuel supply system when the engine system is serviced. The second fuel is supplied to module 130 through reference fuel inlet 142 which is fluidly connected to pressure regulator 176.

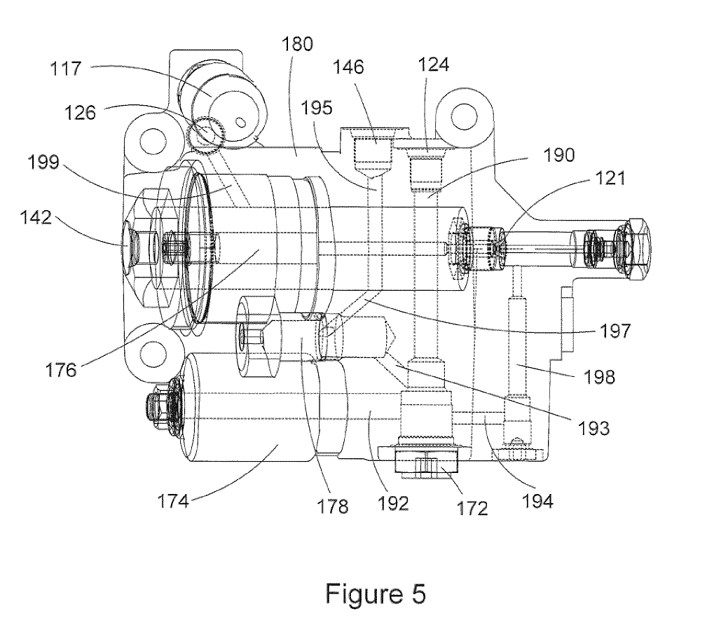

The first fuel exits module 130 through outlet 126 at a pressure that maintains a predetermined bias to the pressure of the second fuel. The second fuel exits pressure regulator valve 175 and flows out of module 130 through outlet 145. In some embodiments outlet 145 is not required if reference fuel inlet 142 is designed to serve both as inlet and outlet. That is, it is possible to design a system in which reference fuel inlet 142 is employed for both supplying second fuel to module 130 at a reference pressure and also as an outlet through which second fuel flows out of module 130, as shown in FIG. 5 and further described below. The first fuel is vented out from module 130 through line 143 and vent outlet 146 when at least one of vent valve 177 and service valve 178 is open.

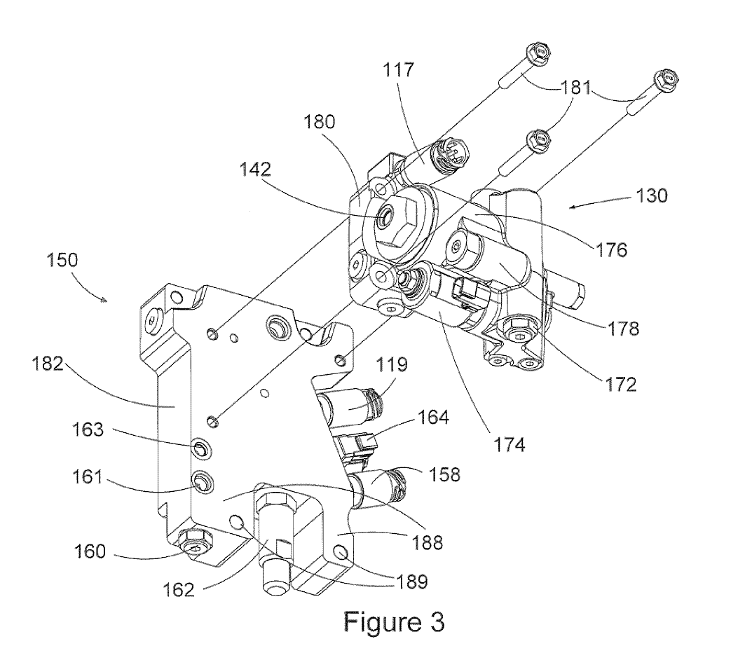

Module 130 for controlling a first fuel rail pressure and second fuel control module 150 are further illustrated in FIG. 3 which shows a three-dimensional view of the two modules and their components. Module 130 comprises a manifold body 180 to which is mounted: pressure regulator 176, check valve 172, shut-off valve 174 and service valve 178, which are each fluidly connected to each other as illustrated in FIG. 2, through internal passages which are shown in more detail in FIG. 5. To provide a reference pressure, the second fuel is supplied to module 130 through reference fuel inlet 142 which is fluidly connected to pressure regulator 176. The second fuel can flow out of module 130 through the same orifice (namely, reference fuel inlet 142), so that no separate outlet is required.

In some embodiments, module 130 comprises fewer elements than illustrated in the present figures. For example, module 130 can comprise only pressure regulator 176, shut-off valve 174 and check valve 172. However, a benefit of disclosed module 130 is that it can be comprise more components to provide an overall arrangement that is more compact, and to further reduce piping and the number of associated connections and potential leak points. For example, module 130 preferably further comprises first fuel rail pressure sensor 117 which is also mounted on manifold body 180. Similarly, if there is sufficient space available on the engine, module 130 can be mated to second fuel control module 150 to further reduce the amount of piping, the potential leak points, and the total volume of high pressure fuel in the fuel delivery system. When there is not enough space to mount module 130 mated to second fuel control module 150, the two modules can be mounted separately. While this is less preferred because it increases the amount of piping and the volume occupied by high pressure fuel, mounting module 130 and second fuel control module 150 separately still provide benefits associated with higher volume manufacturing, and by integrating all of the components and using internal fluid passages within each of the modules.

In a preferred embodiment, second fuel control module 150 comprises manifold body 182 to which is mounted pressure relief valve 162, second fuel return valve 164, second fuel return pressure sensor 158, second fuel rail pressure sensor 119 and second fuel drain check valve 160. In other embodiments second fuel control module comprises fewer components. For example second fuel control module can comprise pressure relief valve 162 and at least one of the second fuel drain check valve 160, second fuel return valve 164, second fuel return pressure sensor 158 and second fuel rail pressure sensor 119.

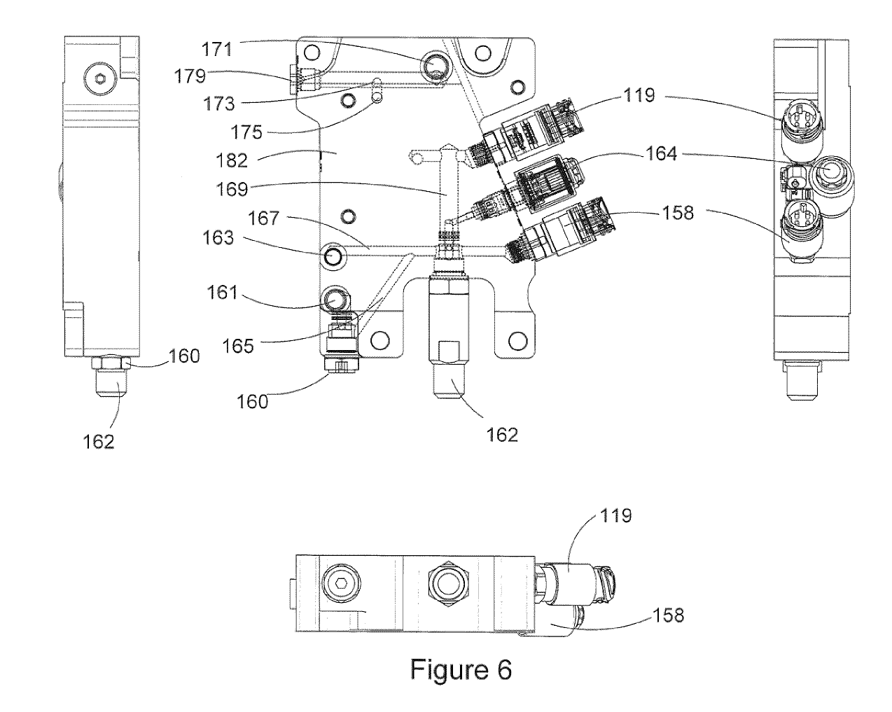

In the illustrated preferred embodiment, internal passages in manifold body 182 fluidly connect the components of second fuel control module 150 to each other, to module 130, to second fuel drain inlet 161, and to second fuel drain outlet 163. These internal passages within manifold body 182 are shown in FIG. 6. In preferred embodiments, manifold body 182 supports additional components of the fuel supply system. For example, manifold body 182 is shaped to accommodate the mounting of pressure relief valve 162. Depending upon the location where manifold body 182 is mounted on the engine, it can further comprise features that reduce the number of structural elements. The illustrated example is designed to be installed near where a filter is mounted to the engine. Normally a spacer is required to provide a mounting point for the filter spaced apart from the engine block. Manifold body 182 is designed with a portion of the body that can be employed as an integral spacer 188 so that a separate spacer piece is not required, providing a simpler arrangement with less pieces. Mounting holes 189 are provided through manifold body 182 for mounting filters 138 (shown schematically in FIG. 1). Manifold body 182 and the described internal passages provide an advantage over previous arrangements by providing a more compact arrangement, reducing the complexity of the fluid connections between different components of the fuel supply system, and reducing the number of potential leak points.

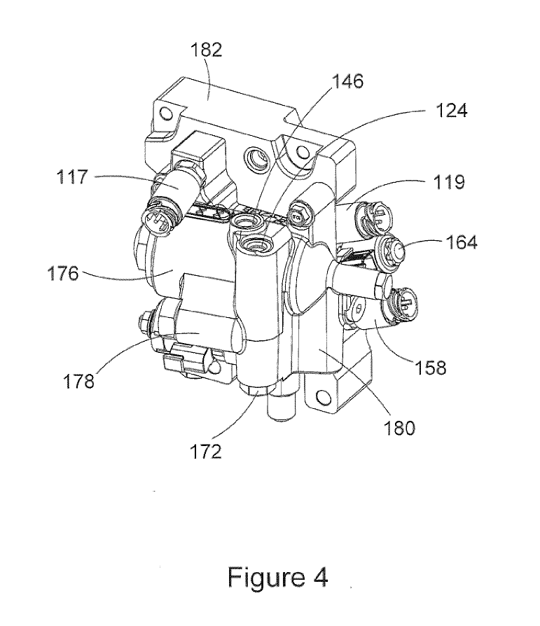

As illustrated in FIGS. 3 and 4 in preferred embodiments, the same advantages achieved by the arrangement of each module can be further achieved by joining module 130 directly to manifold body 182 of second fuel control module 150 to form a fluid tight seal there between with the internal passages of module 130 in communication with the internal passages of module 150 as shown schematically in FIG. 1. Mounting hardware 181, such as bolts, clamps, or other fastening means can be used to join the two modules together as shown in FIG. 4.

FIG. 5 shows the internal passages within manifold body 180 of module 130. As illustrated in FIG. 5, check valve 172 is fluidly connected to inlet 124 through passage 190. Check valve 172 is also fluidly connected to shut-off valve 174 through passage 192 and to service valve 178 through passage 193. The first fuel flows to pressure regulator 176 from inlet 124 by flowing through passage 190, then check valve 172, then passages 194 and 198, and then to first inlet 121. The second fuel flows to pressure regulator 176 through reference fuel inlet 142. Vent outlet 146 is also fluidly connected to pressure regulator 176 through passage 195 and to service valve 178 through passages 195 and 197. The first fuel exits module 130 through outlet 126 having a pressure that is controlled by pressure regulator 176. Outlet 126 is fluidly connected to the outlet of pressure regulator 176 through passage 199.

FIG. 6 illustrates orthographic views of second fuel control module 150, namely the front view, the left and right side views and the top view. The front view shows in dashed lines the internal passages within manifold body 182 that fluidly connect the different components that are installed in manifold body 182. As illustrated in FIG. 6 check valve 160 is fluidly connected to second fuel drain inlet 161 and further through passages 165, 167 and 169 to second fuel rail pressure sensor 119, second fuel return valve 164, second fuel return pressure sensor 158 and pressure relief valve 162. Check valve 160 is also fluidly connected through passage 167 to second fuel drain outlet 163. Piping to first fuel rail 116 (shown in FIG. 1) is connected to port 171, which is fluidly connected to the internal passages of module 130 by passage 173 and port 175, which is fluidly connected to outlet 126 of module 130. Passage 173 can be formed by drilling from the left side as shown in the front view of FIG. 6, and then plugged with plug 179.

In FIGS. 5 and 6, to better illustrate the internal passages and how they are fluidly connected, the passages are not drawn to scale, are partly schematic, and certain physical details not necessary for the understanding of this arrangement are not shown. For example, FIG. 5 does not show the details on how the outlet of pressure regulator 176 is fluidly connected to outlet 126 or the details on how vent outlet 146 is fluidly connected to pressure regulator 176.

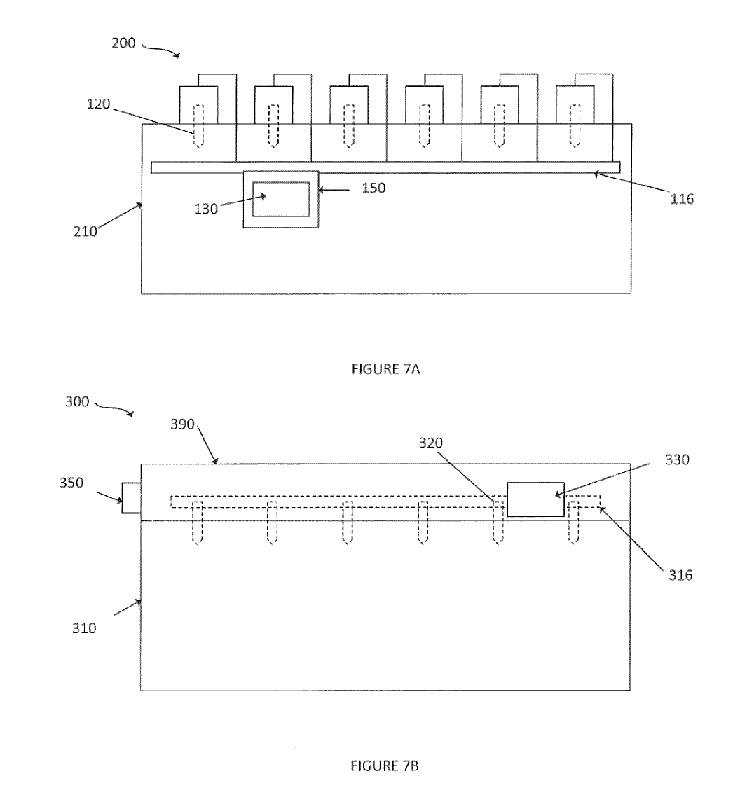

As described above and illustrated in FIGS. 3 and 4, module 130 for controlling the pressure of the first fuel can be mounted on manifold body 182 of second fuel control module 150. This is the preferred arrangement when there is sufficient space available to mount this combined assembly of modules 130 and 150. This arrangement is illustrated in FIG. 7A which represents an engine 200 comprising six cylinders, each provided with a respective injector 120 and an engine block 210. In the embodiment illustrated in FIG. 7A first fuel rail 116 is an external fuel rail, which is mounted on the engine block. Module 130 is mounted on second fuel control module 150 as schematically represented here and the assembly of the two modules is mounted on engine block 210. This is a simplified schematic view that only shows the components necessary for understanding this embodiment. However, those familiar with engines will understand that there are many more other components mounted to an engine block, such as fuel pumps, oil filters, engine control units, water/coolant pumps and associated hoses for circulating the engine coolant.

The disclosed modules can be mounted in other locations one the engine assembly such as to the cylinder head or at other locations in the engine bay of the vehicle in which the engine is mounted, for example, to the vehicle frame. In these embodiments, modules 130 and 150 are preferably located close to the fuel injectors to reduce the amount of piping between the modules and the fuel rails, and at a location that also reduces the piping between the modules and the fuel supply system.

Another advantage of the disclosed modular arrangement is that if an engine does not have sufficient space to mount a combined assembly of modules 130 and 150, these modules can be mounted separately. With reference to FIG. 7B, engine 300 has an engine block 310, a cylinder head 390 and an internal first fuel rail 316 which is provided within cylinder head 390. Injectors 320 are fluidly connected to first fuel rail 316. In this embodiment, module 330 functions as module 130 described in other embodiments, controlling the pressure of the first fuel and it is mounted on cylinder head 390 where space is available, and second fuel control module 350, which functions in the same way as module 150 as described with respect to other embodiments, is mounted on cylinder head 390 but at a different location, where space is available. Modules 330 and 350 are fluidly connected through piping to function in the same way as in other embodiments with the only difference being that these two modules are not joined together. The location of modules 330 and 350 in FIG. 7B is to illustrate by way of example that these modules can be mounted in different locations, but it will be understood that they could be mounted in other locations, depending upon the design of a particular engine and where there is space available.

There can be a long development period for the design of engine components. Beyond the time needed for the design, the development process also includes time for validation and testing. Durability testing can simulate thousands of hours of operation in the field. An advantage of the disclosed modular fuel pressure control assembly is that the same basic design can be used for many different engine types, even if there are constraints on the available space. If there is sufficient space then a preferred embodiment is the combined assembly for both modules 130 and 150. If sufficient space is not available, then the modules can be mounted in different locations but the same design can be used. Features like an spacer can be incorporated into the manifold body to facilitate installation on certain engines without changing the basic design of the modules.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. A module for controlling a first fuel rail pressure in an internal combustion engine and maintaining a predetermined pressure bias with a second fuel rail pressure, both fuels being directly injected into a combustion chamber, said module comprising:
a manifold body comprising an inlet into said manifold body for receiving said first fuel into internal fuel passages defined by said manifold body, and an outlet from said manifold body for delivering said first fuel to a first fuel rail;
a pressure regulator for controlling the rail pressure of said first fuel as a function of said second fuel rail pressure which is used as a reference pressure for maintaining said pressure bias, said pressure regulator comprising:
a first inlet for receiving said first fuel which is fluidly connected through a first passage provided in said manifold body to said inlet of said manifold body;
a second inlet for receiving said second fuel; and
an outlet for delivering said first fuel with said predetermined pressure bias, said outlet being fluidly connected through a second passage provided in said manifold body to said outlet of said manifold body;
a check valve having an inlet fluidly connected through said first passage to said inlet of said manifold body and to said pressure regulator; and
a shut-off valve for shutting down fluid flow to said first fuel rail, having an inlet fluidly connected through said first passage to said inlet of said manifold body;
wherein said pressure regulator, said check valve and said shut-off valve are installed on said manifold body to form a unitary and independent structure.

2. The module of claim 1 further comprising a vent outlet for venting first fuel from said module, said vent outlet being fluidly connected to said pressure regulator through a third passage provided in said manifold body.

3. The module of claim 2 further comprising a service valve for venting fuel from said module during servicing, said service valve being installed on said manifold body and being fluidly connected through said third passage to said vent outlet.

4. The module of claim 1 further comprising a pressure sensor for measuring the pressure in said first fuel rail, said pressure sensor being installed on said manifold body and being connected through an internal passage to said outlet of said manifold body.

5. The module of claim 1 wherein said manifold body is installed on a manifold body of a second fuel control module for controlling second fuel rail pressure.

6. The module of claim 5 wherein said manifold body of said second fuel control module has a second fuel drain inlet, a second fuel drain outlet, a port for fluidly connecting second fuel control module to said module for controlling said first fuel rail pressure and a port for fluidly connecting said manifold body of said second fuel control module to a first fuel rail.

7. The module of claim 6 wherein said second fuel control module further comprises a second fuel pressure relief valve which is mounted on said manifold body of said second fuel control module and which is fluidly connected through passages in said manifold body of said second fuel control module to said second fuel drain inlet and to said second fuel drain outlet.

8. The module of claim 7 wherein said second fuel control module further comprises at least one of a second fuel return valve, a second fuel return pressure sensor, a second fuel rail pressure sensor and a second fuel drain check valve which can be mounted on said body of said second fuel control module and are fluidly connected through passages in said manifold body of said second fuel control module to said second fuel drain inlet and to said second fuel drain outlet.

9. The module of claim 5 wherein said manifold body of said second fuel control module has at least one prolonged end which is shaped to accommodate the mounting of a system component.

10. The module of claim 9 wherein said system component is a filter for said second fuel.

11. The module of claim 5 wherein an assembly formed by said module for controlling said first fuel rail pressure and said second fuel control module is mounted on an engine block, on a cylinder head of said engine or on a frame of a vehicle which is powered by said engine.

12. The module of claim 1 wherein said manifold body of said module for controlling first fuel rail pressure is mounted on a cylinder head of said engine, on an engine block or on a frame of a vehicle that is powered by said engine and is fluidly connected to a second fuel control module that is mounted on said cylinder head, on said engine block or on said frame separately from said module for controlling said first fuel rail pressure.

13. A method of installing a module for controlling a first fuel rail pressure on board of an internal combustion engine fuelled with a first fuel and a second fuel which are directly injected into a combustion chamber of said engine, said module comprising a manifold body, a regulator for controlling the pressure of said first fuel to maintain a predetermined pressure bias with a second fuel rail pressure, a shut-off valve and a check valve, said method comprising:
a. placing said manifold body of said module for controlling first fuel rail pressure on a manifold body of a second fuel control module and mounting it thereto;
b. placing said manifold body of said second fuel control module on an engine block, on a cylinder head of said engine or on a frame of a vehicle powered by said engine and
c. fluidly connecting said manifold body of said module for controlling first fuel rail pressure to a first fuel supply and a first fuel rail.

14. A method of installing a module for controlling a first fuel rail pressure on board of an internal combustion engine fuelled with a first fuel and a second fuel which are both directly injected into a combustion chamber of said engine, said module comprising a manifold body, a regulator for controlling the pressure of said first fuel to maintain a predetermined pressure bias with a second fuel rail pressure, a shut-off valve and a check valve, said method comprising:
a. placing said manifold body of said module for controlling first fuel rail pressure on a cylinder head, on an engine block or on a frame of a vehicle powered by said engine and mounting it thereto; and
b. fluidly connecting said manifold body of said module for controlling first fuel rail pressure with components of a second fuel control module which is mounted on said cylinder head, to a first fuel supply and to a first fuel rail.

15. A module for controlling a first fuel rail pressure in an internal combustion engine and maintaining a predetermined pressure bias with a second fuel rail pressure, both fuels being directly injected into a combustion chamber, said module comprising:
a manifold body comprising an inlet into said manifold body for receiving said first fuel into internal fuel passages defined by said manifold body, and an outlet from said manifold body for delivering said first fuel to a first fuel rail;
a pressure regulator for controlling the rail pressure of said first fuel as a function of said second fuel rail pressure which is used as a reference pressure for maintaining said pressure bias, said pressure regulator comprising:
a first inlet for receiving said first fuel which is fluidly connected through a first passage provided in said manifold body to said inlet of said manifold body;
a second inlet for receiving said second fuel; and
an outlet for delivering said first fuel with said predetermined pressure bias, said outlet being fluidly connected through a second passage provided in said manifold body to said outlet of said manifold body;
a shut-off valve for shutting down fluid flow to said first fuel rail, having an inlet fluidly connected through said first passage to said inlet of said manifold body;
wherein said pressure regulator and said shut-off valve are installed on said manifold body to form a unitary and independent structure.

16. The module of claim 15 further comprising a vent outlet for venting first fuel from said module, said vent outlet being fluidly connected to said pressure regulator through a third passage provided in said manifold body.

17. The module of claim 15 further comprising a pressure sensor for measuring the pressure in said first fuel rail, said pressure sensor being installed on said manifold body and being connected through an internal passage to said outlet of said manifold body.

18. The module of claim 15 wherein said manifold body is installed on a manifold body of a second fuel control module for controlling second fuel rail pressure.

19. The module of claim 18 wherein said manifold body of said second fuel control module has a second fuel drain inlet, a second fuel drain outlet, a port for fluidly connecting second fuel control module to said module for controlling said first fuel rail pressure and a port for fluidly connecting said manifold body of said second fuel control module to a first fuel rail.

20. The module of claim 19 wherein said second fuel control module further comprises at least one of a second fuel pressure relief valve, a second fuel return valve, a second fuel return pressure sensor, a second fuel rail pressure sensor and a fuel drain check valve which can be mounted on said body of said second fuel control module and are fluidly connected through passages in said manifold body of said second fuel control module to said second fuel drain inlet and to said second fuel drain outlet.
